(19) United States
(12) Patent Application Publication
(10) Pub. No.: US 2006/0070822 A1
(43) Pub. Date: Apr. 6, 2006

(54) Sheave for elevator

(75) Inventors: Akira Osada, Kawagoe-shi (JP); Noboru Hiruma, Tokyo (JP)

Correspondence Address: FOLEY AND LARDNER LLP;SUITE 500, 3000 K STREET NW, WASHINGTON, DC, 20007, US

(73) Assignee: TOSHIBA ELEVATOR KABUSHIKI KAISHA

(21) Appl. No.: 11/222,796

(22) Filed: Sep. 12, 2005

Related U.S. Application Data
(63) Continuation of application No. PCT/JP04/08672, filed on Jun. 15, 2004.

(30) Foreign Application Priority Data
Jun. 18, 2003 (JP) 2003-173582

(51) Int. Cl. B66B 5/00

(52) U.S. Cl. 187/350

(57) ABSTRACT

Coating layers of low-friction coating materials helping a rotating action generated on ropes are provided on surfaces of grooves formed on an outer peripheral surface of a base of a sheave. Thus, difference in tension between the ropes can be solved, generation of twist on the ropes can be prevented, and deterioration of portions of the ropes which are in contact with the sheave can be prevented to extend the lifetime of the ropes.

### CROSS-REFERENCE TO RELATED APPLICATIONS

This is a Continuation Application of PCT Application No. PCT/JP2004/008672, filed Jun. 15, 2004, which was published under PCT Article 21(2) in English.

This application is based upon and claims the benefit of priority from prior Japanese Patent Application No. 2003-173582, filed Jun. 18, 2003, the entire contents of which are incorporated herein by reference.

### BACKGROUND OF THE INVENTION

1. Field of the Invention

This invention relates to a sheave suitable for a 2-to-1 roping type machine room-less elevator allowing a traction machine to be provided in a hoistway.

2. Description of the Related Art

2-to-1 roping type elevators are installed in residential buildings, mid-rise office buildings and the like. The 2-to-1 roping type indicates a method of hanging a car and a counter weight without directly connecting a rope to the car or the counter weight. On the other hand, a 1-to-1 roping type indicates a method of hanging a car and a counter weight by directly connecting a rope to the car or the counter weight.

In the 2-to-1 roping type elevator, a rope is wound round a main sheave connected to the traction machine. An end of the rope is fixed to a first rope hitch via a first sheave attached to a lower portion of the car and the other end of the rope is fixed to a second rope hitch via a second sheave attached to the counter weight. The first and second rope hitches are provided at upper portions of the hoistway where both ends of the rope are fixed.

In other words, in the 2-to-1 roping type elevator, the rope supports the car and the counter weight via the first and second sheaves, respectively, and the car and the counter weight are controlled by use of friction between the main sheave and the rope.

In this structure, since a load applied to the main sheave is half of entire weight (i.e. weight of the car and the counter weight), the rope driving system such as the traction machine can be downsized. For this reason, the 2-to-1 roping type is most suitable for the machine room-less elevator which allows the hoistway to accommodate the driving system and is applied to many residential buildings, low-rise and mid-rise office buildings and the like.

In the above-described 2-to-1 roping type elevator, however, there is a problem that since the rope is wound round many sheaves the rope has much fatigue.

Moreover, if the rope is twisted the twisted portion is caught by grooves of the sheaves. Thus, frictional resistance between the rope and the sheaves is increased by a force of a direction of releasing the twist and specific portions of the rope are remarkably deteriorated.

### BRIEF SUMMARY OF THE INVENTION

An object of the present invention is to provide a sheave for elevator, capable of reducing fatigue of ropes, restricting deterioration of specific portions of the ropes and extending the lifetime of the ropes.

According to an aspect of the present invention, there is provided a sheave for elevator, capable of moving up and down a car and a counter weight by a rope wound round a main sheave connected to a traction machine provided in a hoistway, the sheave comprising: a groove in which the rope is fitted at an outer peripheral surface of a base; and a coating layer of a low-friction coating material, which is provided on surfaces of the groove and which helps a rotating action generated on the rope.

According to another aspect of the present invention, there is provided a sheave for elevator, capable of moving up and down a car and a counter weight by ropes wound round a main sheave connected to a traction machine provided in a hoistway, the sheave comprising: a plurality of rope-corresponding sheaves configured to have grooves in which the respective ropes are fitted, with one-to-one relationship with the respective ropes, the plurality of rope-corresponding sheaves being arranged side by side to rotate independently of each other, on a shaft attached to any one of the car and the counter weight.

### BRIEF DESCRIPTION OF THE SEVERAL VIEWS OF THE DRAWING

FIG. 1 is an illustration of a 2-to-1 roping type elevator employing a sheave according to a first embodiment of the present invention;

FIG. 2 is a partially sectional view showing a structure of a sheave used in the elevator;

FIG. 3 is a partially sectional view showing another structure of the sheave used in the elevator;

FIG. 4 is an illustration of a 1-to-1 roping type elevator; and

FIG. 5 is a partially sectional view showing a structure of a sheave according to a second embodiment of the present invention.

### DETAILED DESCRIPTION OF THE INVENTION

Embodiments of the present invention will be explained below with reference to the accompanying drawings.

### First Embodiment

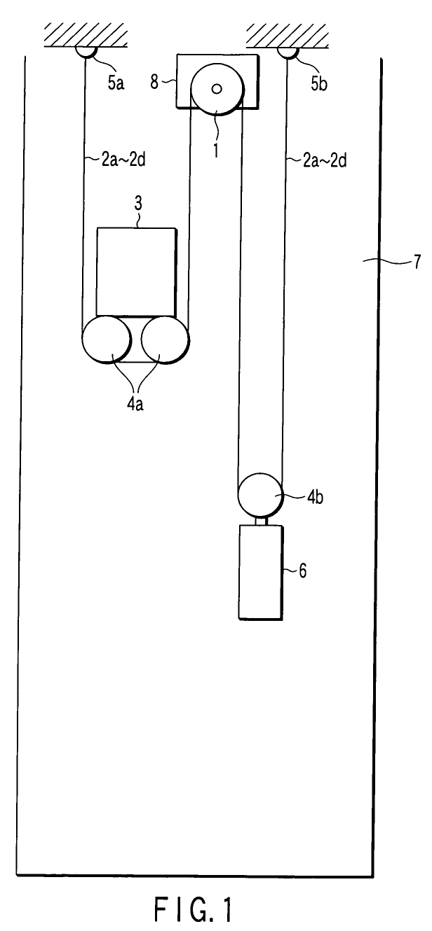

FIG. 1 is an illustration of a 2-to-1 roping type elevator employing a sheave according to a first embodiment of the present invention.

The elevator is machine room-less and a traction machine 8 is provided in a hoistway 7. A main sheave 1 is coupled to a drive shaft of the traction machine 8. A plurality of (four, in this embodiment) ropes 2a to 2d are wound round an outer peripheral surface of the main sheave 1.

One-side ends of the ropes 2a to 2d are fixed to a rope hitch 5a via sheaves 4a provided on a lower portion of a car 3. Other-side ends of the ropes 2a to 2d are fixed to a rope hitch 5b via a sheave 4b provided on a counter weight 6.

The sheaves 4a restrict passage of the ropes 2a to 2d between the main sheave 1 and the rope hitch 5a and support the car 3. The sheave 4b restrict passage of the ropes 2a to 2d between the main sheave 1 and the rope hitch 5b and support the counter weight 6. The rope hitches 5a and 5b are provided on a top portion of the hoistway 7.

In other words, in the 2-to-1 roping type elevator, the ropes 2a to 2d support the car 3 and the counter weight 6 via the sheaves 4a and 4b, respectively. The car 3 and the counter weight 6 are driven, similarly to well buckets, by using the friction between the main sheave 1 and the ropes 2a to 2d.

Next, a structure of the sheaves used for the 2-to-1 roping type elevator will be explained.

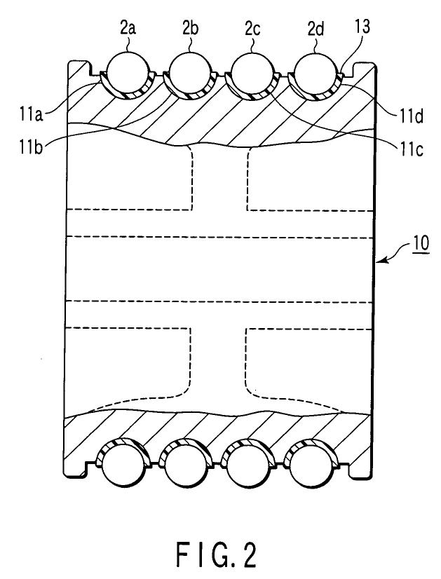

FIG. 2 is a partially sectional view showing a structure of the sheave used in the present invention. A sheave 10 corresponds to the sheaves 4a and 4b shown in FIG. 1.

The sheave 10 comprises a base 12 having on its outer peripheral surface grooves 11a to 11d whose number at least corresponds to the number of the ropes 2a to 2d wound round the main sheave 1, and coating layers 13 provided on respective surfaces of the grooves 11a to 11d of the base 12.

The coating layers 13 are formed of low-friction materials helping a rotating action generated on the ropes 2a to 2d.

By arranging the sheaves 10 comprising the coating layers 13 in place of the sheaves 4a and 4b shown in FIG. 1, the following advantage can be obtained.

The ropes 2a to 2d move via the sheaves 4a and 4b in accordance with the rotation of the main sheave 1, such that the car 3 and the counter weight 6 move up and down, during operation of the elevator.

When tension is applied to the ropes 2a to 2d, torque (rotation torque) is generated on the ropes 2a to 2d in a direction of releasing the twist about an axis of each of the ropes.

In the 2-to-1 roping type elevator, since the sheaves 4a and 4b and the like have an action of maintaining the twist of the ropes 2a to 2d, the ropes 2a to 2d can hardly move (rotate) in a direction of releasing their twist. For this reason, a problem arises that the ropes 2a to 2d in the twisted state repeatedly make a high-friction contact and specific portions of the ropes 2a to 2d are remarkably deteriorated.

In the machine room-less elevator, in particular, since the distance between the main sheave 1 and the sheaves 4a or the sheave 4b becomes shorter the variation in tension becomes greater in accordance with the difference in diameter between the sheaves 4a and 4b, the difference in diameter between the ropes 2a to 2d, and the like. For this reason, there is a problem that the ropes can easily be twisted and deteriorated.

To solve this problem, the coating layers 13 formed of low-friction materials are provided on the surfaces which are in contact with the ropes 2a to 2d (i.e. surfaces of the grooves 11a to 11d of the base 12), in the sheave 10 (sheaves 4a, 4b) of the present invention. Thus, for example, if difference in tension between the ropes 2a to 2d is made, the ropes 2a to 2d smoothly slide on the surfaces of the coating layers 13 in accordance with the tension so as to make the difference in tension smaller.

In other words, for example, even if the amount of the ropes 2a to 2d fed from the main sheave 1 is greatly varied in accordance with the difference in diameter between the sheaves 4a and 4b, the difference in diameter between the ropes 2a to 2d, and the difference in tension (difference in elongation) and is expressed as the difference in tension, the tension is dispersed within the entire length of the ropes including sections from the sheave 10 to the rope hitches 5a and 5b and the ropes 2a to 2d can be prevented from being twisted.

Moreover, since the coating layers 13 provided on the surfaces of the respective grooves of the base 12 of the sheave 10 are formed of coating members of low-friction materials, the coating layers 13 act to relax the restriction of rotation of the ropes 2a to 2d. For this reason, even if the ropes 2a to 2d are twisted, they can easily be rotated in a direction of releasing the twist. Thus, deterioration of specific portions of the ropes 2a to 2d can be prevented and their lifetime can be extended.

Preferable examples of the low-friction materials of the coating layers 13 are fluorocarbon resin (PTFE, ETFE and the like) and polyethylene that are, generally, used widely as sliding materials. PTFE is derived from TFE (tetrafluoroethylene) obtained by processing flon 22 (CHClF₂) in thermal decomposition and is produced by suspension or emulsion polymerization. ETFE is an alternating copolymer of TFE and ethylene. If fluorocarbon resin (PTFE, ETFE and the like) is especially used for the coating members of the low-friction materials, resistance to wear is improved by adding glass fibers to the fluorocarbon resin as a filler.

In addition, if graphite or molybdenum disulfide is added together with glass fibers as a filler, a friction coefficient can be lowered.

In other words, the lifetime of the ropes 2a to 2d can be extended by using fluorocarbon resin (PTFE, ETFE and the like) as the base of the coating layers 13 and selectively adding either of glass fibers, glass fibers and graphite, and glass fibers and molybdenum disulfide to the base.

In the first embodiment, the sheaves 4a configured to move up and down the car 3 and the sheave 4b configured to move up and down the counter weight 6 have been described. From the viewpoint of the function of restricting the rope passage, however, the same advantage can also be obtained from a deflector sheave (i.e. a sheave arranged to prevent the car from hitting the counter weight). The concept of the sheave 10 of the present invention includes a deflector sheave.

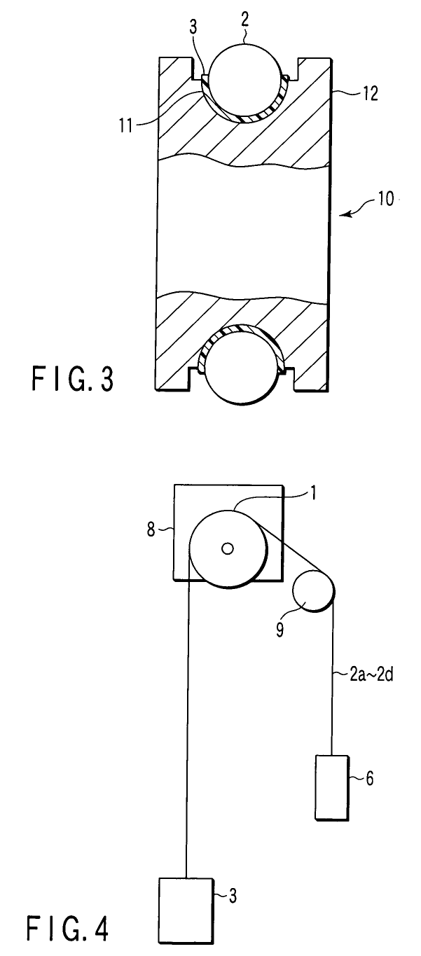

Even if the sheave 10 has a groove 11 corresponding to a single rope 2 on the outer peripheral surface of a base 12 as shown in FIG. 3, the same advantage as described above can be obtained by providing the coating layer 13 of low-friction materials on the groove 11.

FIG. 4 shows a one-to-one roping type elevator. In the one-to-one roping type elevator, the ropes 2a to 2d are directly connected to the car 3 and the counter weight 6.

9 denotes a deflector sheave. The same advantage as described above can be obtained by replacing a deflector sheave 9 with the sheave 10 comprising the coating layer 13 of the above-described low-friction materials.

### Second Embodiment

Next, a second embodiment of the present invention will be described.

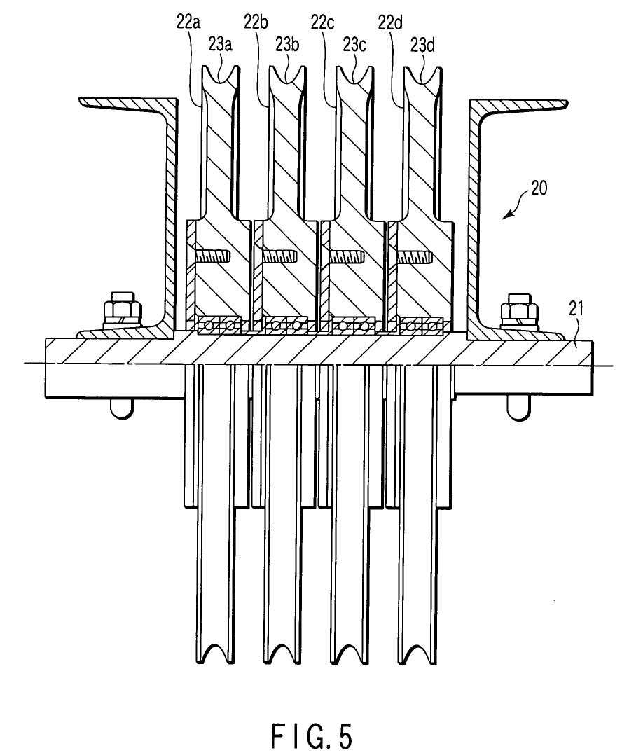

FIG. 5 is a partially sectional view showing a structure of a sheave according to the second embodiment of the present invention. Similarly to the sheave 10, a sheave 20 shown in FIG. 5 corresponds to the sheaves 4a and 4b in FIG. 1.

The sheave 20 comprises a shaft 21 attached to the car 3 or the counter weight 6, and rope-corresponding sheaves 22a to 22d corresponding to a plurality of (four, in this embodiment) ropes, which are arranged side by side with an equal interval along an axial direction of the shaft 21.

The number of rope-corresponding sheaves 22 a to 22d is equal to the number of the ropes 2a to 2d wound round the main sheave 1 shown in FIG. 1. The sheaves 22a to 22d are provided to rotate about the shaft 21 independently of each other. A plurality of grooves 23a to 23d in which the ropes 2a to 2d are wound are formed on outer peripheral surfaces of the rope-corresponding sheaves 22a to 22d, respectively.

In this structure, the plural rope-corresponding sheaves 22a to 22d of the sheave 20 are capable of rotating independently of each other. Even if there is a difference in tension between the ropes 2a to 2d fed from the main sheave 1, the problem of the difference in tension can be solved by independent movement of the rope-corresponding shaves 22a to 22d. Thus, generation of the twist of the ropes 2a to 2d caused by the difference in tension can be prevented and the lifetime of the ropes can be extended.

Needless to say, the concept of the sheave 20 includes a deflector sheave.

The present invention is not limited to the embodiments described above and can be modified in various manners without departing from the spirit and scope of the invention.

The embodiments can be combined as much as possible and, in this case, advantages can be obtained from the combination. Furthermore, the embodiments contain various generic and specific aspects of the invention. Thus, various aspects of the invention can also be extracted from any appropriate combination of a plurality of constituent elements disclosed in the embodiments. For example, if an invention is extracted by omitting some of the constituent elements described in the means for solving the problem, well-known and well-employed techniques will compensate for the omitted portions in accomplishment of the extracted invention.

According to the present invention, as described above, variation in tension caused together with operation of the elevator can be reduced, and the lifetime of the ropes can be remarkably extended by facilitating the rotation of the ropes.

1. A sheave for elevator, capable of moving up and down a car and a counter weight by a rope wound round a main sheave connected to a traction machine provided in a hoistway, the sheave comprising:
a groove in which the rope is fitted at an outer peripheral surface of a base; and
a coating layer of a low-friction coating material, which is provided on surfaces of the groove and which helps a rotating action generated on the rope.

2. The sheave for elevator according to claim 1, wherein a plurality of grooves whose number corresponds to number of a plurality of ropes are formed on the outer peripheral surface of the base, and a plurality of coating layers of the low-friction coating material are provided on the surfaces of the plurality of grooves.

3. The sheave for elevator according to claim 1, wherein the low-friction coating material is fluorocarbon resin.

4. The sheave for elevator according to claim 1, wherein fluorocarbon resin is used as a base material of the low-friction coating material, and one of glass fiber, glass fiber and graphite, and glass fiber and molybdenum disulfide is added to the fluorocarbon resin base material as filler.

5. The sheave for elevator according to claim 1, wherein the low-friction coating material is polyethylene.

6. A sheave for elevator, capable of moving up and down a car and a counter weight by ropes wound round a main sheave connected to a traction machine provided in a hoistway, the sheave comprising:
a plurality of rope-corresponding sheaves configured to have grooves in which the respective ropes are fitted, with one-to-one relationship with the respective ropes, the plurality of rope-corresponding sheaves being arranged side by side to rotate independently of each other, on a shaft attached to any one of the car and the counter weight.
